(19) United States
(12) Patent Application Publication
(10) Pub. No.: US 2005/0080894 A1
(43) Pub. Date: Apr. 14, 2005

(54) Method and system for topology adaptation to support communication in a communicative environment

(76) Inventors: John Apostolopoulos, Palo Alto, CA (US); Nina Bhatti, Mountain View, CA (US); W. Bruce Culbertson, Palo Alto, CA (US); Daniel G. Gelb, Redwood City, CA (US); Michael E. Goss, Burlingame, CA (US); Thomas Malzbender, Palo Alto, CA (US); Kei Yuasa, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/683,136

(22) Filed: Oct. 9, 2003

(51) Int. Cl. G06F 15/173

(52) U.S. Cl. 709/224

(57) ABSTRACT

A method and system for topology adaptation. Specifically, one embodiment of the present invention discloses a method for topology adaptation to support communication in a communicative environment. The embodiment of the method begins by measuring at least one performance metric for a plurality of nodes associated with a plurality of collaborators in the communicative environment. Then, the embodiment of the method dynamically adapts a communication topology for linking the plurality of nodes in the communication network to support communication in the communicative environment based on the at least one performance metric.

### RELATED UNITED STATES PATENT APPLICATION

This application is related to U.S. patent application Ser. No. 10/176,494 by Thomas Malzbender et al., filed on Jun. 21, 2002, entitled “Method and System for Real-Time Video Communication Within a Virtual Environment” with attorney docket no. 100203292-1, and assigned to the assignee of the present invention.

### TECHNICAL FIELD

The present invention relates to the field of communication networks, and more particularly to a method and system for topology adaptation to support communication in a virtual environment.

### BACKGROUND ART

A communication network to support a virtual environment supported by N participants can be quite complex. In a virtual environment supported by N participants, there are N nodes within the communication network. For a full richness of communication, each node that represents a participant may generate a different data stream to send to each of the other nodes. There is a computational cost associated with producing each data stream. In addition, there is a communication cost associated with transmitting data streams between the nodes.

As the number N of participants grows, computational and communication bandwidth complexities increase in order to support the increasing number of participants. As such, maintaining scalability of the communication network as the number N increases becomes more important. For example, in the case where a different data stream is sent to each of the other participants, the local computer must generate and transmit N−1 data streams, one for each of the other participants. At the local level, computational complexity scales with the number of participants. As such, as the number N of participants increases, the computational capacity of the local computer may be exceeded depending on the processing power capabilities of the local computer. As such, the amount of computation will become prohibitive as N grows.

At the network level, when each of the N participants are generating a separate data stream for each of the other participants, this leads to a total of N(N-1) data streams that are transmitted over the entire communication network. Both at the local and network levels, the amount of communication transmitted over the network may exceed the network's capabilities as N grows. As such, the amount of communication will become prohibitive as N grows.

What is needed is a reduction in both computational complexity and communication traffic under certain conditions. As such, immersive communication systems will be able to scale to larger values of N.

### DISCLOSURE OF THE INVENTION

A method and system for topology adaptation. Specifically, one embodiment of the present invention discloses a method for topology adaptation to support communication in a communicative environment. The embodiment of the method begins by measuring at least one performance metric for a plurality of nodes associated with a plurality of collaborators in the communicative environment. Then, the embodiment of the method dynamically adapts a communication topology for linking the plurality of nodes in the communication network to support communication in the communicative environment based on the at least one performance metric.

### BRIEF DESCRIPTION OF THE DRAWINGS

FIG. 1 is a diagram of an underlying communication network that supports an N-way collaborative environment, in accordance with one embodiment of the present invention.

FIG. 2 is a flow diagram illustrating steps in a computer implemented method for topology adaptation for supporting an N-way collaborative virtual environment, in accordance with one embodiment of the present invention.

FIG. 3A is a diagram of a full-mesh topology that supports communication between nodes in an N-way collaborative environment, in accordance with one embodiment of the present invention.

FIG. 3B is a diagram of a star topology that supports communication between nodes in an N-way collaborative environment, in accordance with one embodiment of the present invention.

FIG. 3C is a diagram of a hybrid topology that supports communication between nodes in an N-way collaborative environment, in accordance with one embodiment of the present invention.

FIG. 3D is a diagram of a hybrid topology that supports communication between nodes in an N-way collaborative environment, in accordance with one embodiment of the present invention.

FIG. 4 is a block diagram of an exemplary system that is capable of topology adaptation for supporting an N-way collaborative virtual environment, in accordance with one embodiment of the present invention.

### BEST MODES FOR CARRYING OUT THE INVENTION

Reference will now be made in detail to the preferred embodiments of the present invention, a method and system for topology adaptation in supporting communication between nodes in a communicative environment. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention can be implemented on software running on a computer system. The computer system can be a personal computer, notebook computer, server computer, mainframe, networked computer, handheld computer, personal digital assistant, workstation, and the like. This software program is operable for providing topology configuration and adaptation to support communication in a communicative environment. In one embodiment, the computer system includes a processor coupled to a bus and memory storage coupled to the bus. The memory storage can be volatile or non-volatile and can include removable storage media. The computer can also include a display, provision for data input and output, etc.

In one embodiment, the communicative environment comprises an N-way collaborative virtual environment. With increasing N, the computational cost associated with producing distinct data stream increases. Data streams are communicated between participants within the N-way collaborative environment. Generating a separate data stream for each of the participants in the N-way collaborative environment can become computationally expensive at a certain point. In addition, the communication cost for transmitting the data streams to each of the nodes within the communication network increases.

Accordingly, the present invention provides a method and system for topology configuration and adaptation to support communication in a communicative environment. As a result, embodiments of the present invention are capable of reducing both computational complexity and communication bandwidth traffic in a communicative environment, such as, an N-way collaborative environment. As such, immersive communication systems will be able to scale to larger values of N.

While embodiments of the present invention are disclosed for configuring and adapting a communication topology to support the transmission of communication data for use in a communicative environment, other embodiments are well suited to network adaptation to support communication within any type in a virtual environment, such as, an N-way collaborative environment.

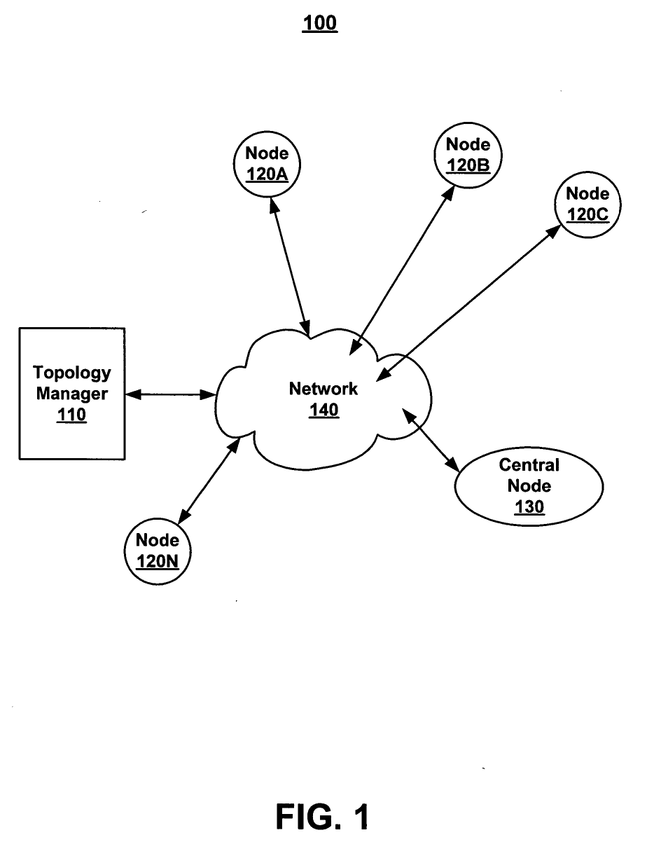

FIG. 1 is a diagram of a exemplary communication network 100 that is capable of supporting a communicative environment (e.g., an N-way collaborative virtual environment), in accordance with one embodiment of the present invention. As shown in FIG. 1, the network 140 facilitates communication between devices and nodes that are communicatively coupled with the network 140. Within the network 140, communication traffic is transmitted through various devices, such as, routers and/or switches. A communication protocol (e.g., TCP/IP protocol) implements the communication through the network 140. For example, the network 140 may comprise the Internet, or a local area network (LAN), a wide area network (WAN), etc. Embodiments of the present invention are well suited to application within a class of communication systems and networks that allow multiple numbers of users or participants to interact in a communicative environment, e.g., the N-way collaborative virtual environment.

In FIG. 1, the network 140 supports an N-way collaborative virtual environment, in one embodiment. Nodes 120A-N comprise the plurality of collaborators that are participating in the N-way collaborative virtual environment in addition, the topology manager 110 configures the communication topology that establishes how the nodes communicate with each other. That is, the topology manager 110 determines the communication paths that are implemented through the communication network 140 to facilitate communication between the collaborators in the N-way collaboration environment.

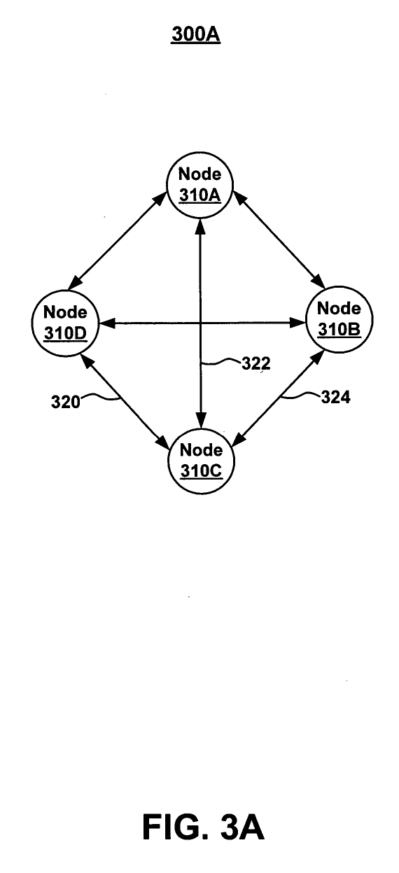

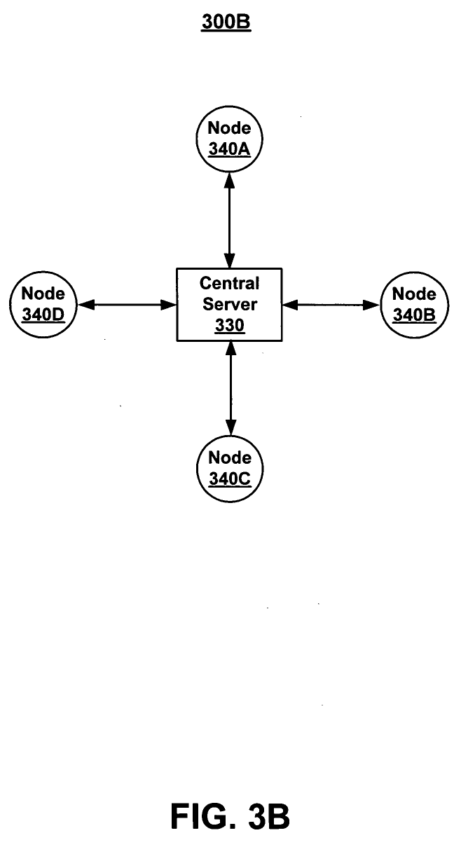

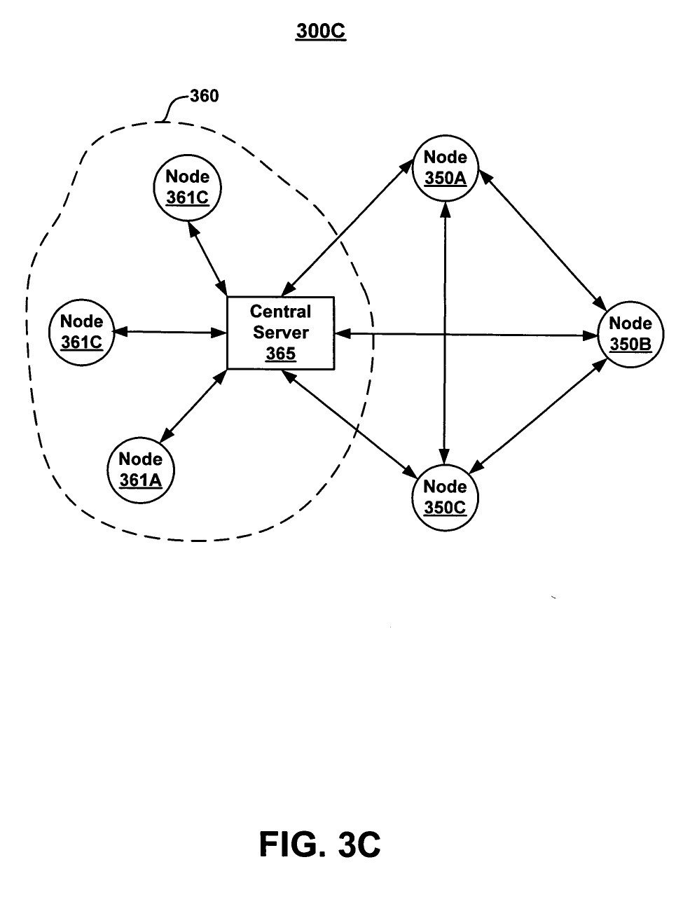

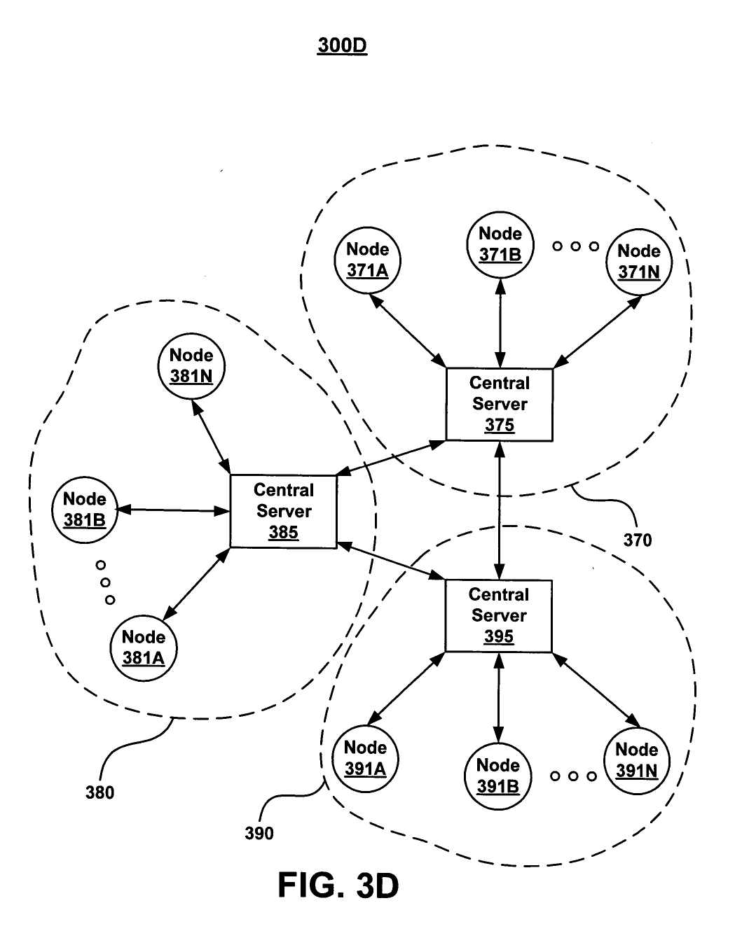

One or more central nodes 130 are also coupled to the network 140 to facilitate communication topologies that require central server capabilities. For example, a star topology implements a central node 130 for providing processing capabilities, as will be further described below in relation to FIG. 3B.

Within the N-way collaborative environment, a collaborator is associated with each of the nodes 120A-N in the communication network 100. Each of the collaborators at each node interacts with the remaining collaborators in order to participate within the N-way collaborative virtual environment. For example, the participant at node 110A communicates with the remaining participants (participants at nodes 110B-N) through the network 140.

The nodes within the communication network 100 can produce data streams for some or all of the other nodes within the communication network 100. In one embodiment, the data streams are user dependent. That is, a sending collaborator sends potentially different data streams to each of the other receiving collaborators. As such, the data stream that is generated by the sending collaborator is dependent upon to which receiving collaborator is receiving the data stream.

In one embodiment, the user dependency is defined by a user's viewpoint within the N-way collaborative virtual environment. In that case, the data streams are generated on a view dependent basis. Also, the N-way collaborative environment comprises a view dependent three-dimensional virtual environment. That is, images in real-time of a sending collaborator (e.g., a sending collaborator) are generated from the viewpoints of receiving collaborator (e.g., receiving collaborator) within the virtual N-way collaborative environment. The images are generated by new view synthesis techniques based on sample video streams of the sending collaborator.

Construction of each of the (N-1) new views of a sending collaborator is done with various new view synthesis techniques. The new view synthesis techniques construct, from the various real-time video streams of the sending collaborator taken from the multiple sample perspectives, a new view taken from a new and arbitrary perspective, such as, the perspective of a receiving collaborator in the virtual environment.

An intermediate step includes rendering a three dimensional model of the sending collaborator, from which the new view of the sending collaborator is generated. The three-dimensional model is generated from the various real-time video streams of the sending collaborator. For example, the 3D model is constructed form synchronous video frames taken from multiple sample camera perspectives. The 3D model forms the basis for creating avatars representing the sending collaborator in the N-way collaborative environment. Renderings of a collaborator's avatar from the perspective of other collaborator are generated. As a result, the images of the avatars are sent to the receiving collaborators. The activity between the nodes participating in the N-way collaborative environment is highly interactive.

In other embodiments, the reconstruct and render module 140 uses an image based visual hull (IBVH) technique to render the three dimensional model of the sending collaborator from the perspective of an observing collaborator. For example, the IBVH technique back projects the contour silhouettes into a three-dimensional space and computes the intersection of the resulting frusta. The intersection, the visual hull, approximates the geometry of the user. Rendering this geometry with view-dependent texture mapping creates convincing new views.

In other embodiments, other reconstruction techniques instead of IBVH and image-based polygonal reconstruction techniques are used to render a three dimensional model of the sending participant from the perspective of an observing participant.

Processing can be accomplished at the local computer associated with the sending collaborator or any suitable intermediate location within the network. As a result, the rendered images and opacity maps are transmitted to all collaborators. That is, the outputs are combined with three dimensional computer generated synthetic renderings of the background to provide for photo-realistic versions of the sending collaborator within the virtual environment. The virtual environment also includes photo-realistic versions of other collaborators. The N-way collaborative environment is viewed by all collaborators from the perspectives of their corresponding avatars within the virtual environment.

While the present embodiment is described within the context of an N-way collaborative environment (e.g., an N-way collaborative video conference), other embodiments are well suited to other environments that provide for interaction between multiple collaborators within the virtual environment.

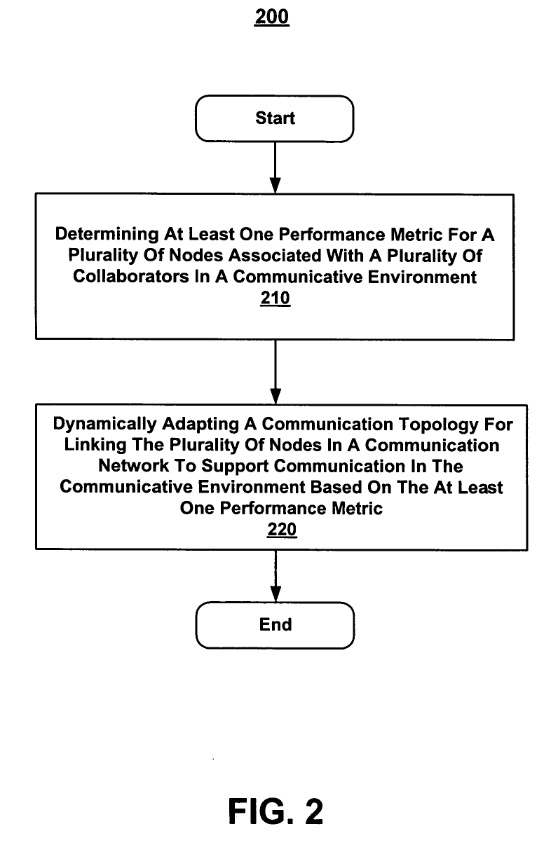

FIG. 2 is a flow chart 100 illustrating steps in a computer implemented method for topology adaptation to support communication in a communicative environment, in accordance with one embodiment of the present invention. In the communicative environment, each participant can possibly transmit data streams (e.g., audio and video data streams) to some or all of the other participants. The present embodiment is capable of adapting the communication topology according to performance metrics to allow for scaling to larger values of N.

At 210, the present embodiment begins by measuring at least one performance metric for a plurality of nodes in a communicative environment (e.g., an N-way collaborative environment). The plurality of nodes are associated with a plurality of collaborators.

In one embodiment, the performance metric comprises a resource performance metric for a plurality of nodes in the virtual environment. The resource performance metrics define resource capabilities at each of the nodes. For example, the performance metric may comprise processing power at the node, and available processing power at the node. Also, the performance metric may comprise application capabilities at the node.

The resource performance metric provides a means for determining the capabilities of the resources at the local node for supporting the communicative environment. For example, if the resource capability of a local node associate with a local collaborator comprises very low processing power, then the processing of data signals used for generating communication traffic in the communicative environment may be transferred to a remote location, such as, at a central server/node.

Various resource limitations can exist at the local nodes. These limitations can be measured and lead to resource performance metrics that can be used to decide when to dynamically adjust the topology of the network, and where computation is performed within it. One of these is compute power, which is how much processing can be done at a node. As the number of receivers grows, the amount of computation that is needed to generate streams increases and at some point the system could decide to move the computation to a server in the network, changing the topology. Another resource limitation is local memory. A node may have insufficient storage space in which to perform the calculations to generate the necessary streams. Local bandwidth availability is another factor, as data must usually be sent between the node's central processing unit (CPU) and the node's memory. As the number of streams to be generated increases there may be insufficient local bandwidth on the node to compute the streams. Another resource could be rendering capability on the receiving node. In the virtual environment scenario for example, the receiver might have insufficient rendering power to render the virtual environment, and may be forced to use servers in the network to offload the rendering computation. Additional resources include input/output bandwidth of each node, and power consumption or battery life of each node. Battery life is a very important resource constraint for laptops, personal digital assistants (PDAs), cell phones, and similar portable devices.

In another embodiment, the performance metric comprises a network performance metric for an underlying communication network that supports communication traffic between the plurality of nodes in the communicative environment. As previously described, the underlying network (e.g., Internet, or corporate LAN) describes the physical network that facilitates communication between each of the collaborator in the communicative environment.

The network performance metric provides a means for determining the capabilities of the network to support the transmission of communication traffic in the communicative environment. For example, the network performance metric may comprise load characteristics such as network bandwidth capabilities, network congestion, delay, delay jitter, loss rate, etc.

There are also multiple network limitations that must be considered when measuring the network performance metrics. The primary limitation usually focuses on bandwidth, as there may be insufficient network bandwidth to transmit the data streams to a number of nodes. If the number of transmitted and received streams would exceed the available bandwidth, the topology may need to be dynamically adjusted. Another limitation is latency. There may be more latency among different nodes in the network, and changing the topology could reduce the overall latency. Loss in the network should also be considered, as not all data that is sent may reach the receiver. Other networking metrics must also be considered.

At 220, the present embodiment continues by dynamically adapting a communication topology for linking the plurality of nodes in the communication network. The plurality of nodes are communicatively coupled to support communication in the communicative environment. The communication topology is configured, and dynamically adapted, based on the performance metric that is determined at a particular time. In one embodiment, at least one resource performance metric is considered when configuring and adapting the communication topology. In another embodiment, at least one network performance metric is considered when configuring and dynamically adapting the communication topology. In still another embodiment, a combination of resource and network performance metrics are considered when configuring and dynamically adapting the communication topology.

The topology adaptation may be user-driven, manager-driven, or network-driven. In the user-driven case, one of the end-user requests/specifies a change in the topology or operation. In the manager-driven case, a manager (e.g. central manager in the star topology) specifies a change in the topology or operation. In the network-driven case, the network manager (either automated system or person) requests/specifies a change in the topology or operation.

Topology adaptation may be performed in a manner that is transparent to the users, or in a manner that the users are aware of the change. When the adaptation is transparent to the users, the users are not aware that a change has occurred. This is an important property in order to make the adaptation seamless to the users, therefore limiting disturbances in the user's collaboration. In addition, transparency is an important property in order to simplify the operation of the application and system from an end-users point of view.

On the other hand, it is sometimes beneficial that all or some of the users are made aware of changes in the operation. For example, if the change leads to the availability of more (or less) computational resources and an end-user is aware of the availability of more (or less) computational resources, the end-user may choose to change his or her use of the computational resources.

As a result, a change in the topology will lead to a change in the network connections between nodes, as well as generally a transfer of state information between appropriate nodes in the topology. For example, when adapting from a mesh to a star topology, appropriate state information from each end-node can be transferred to the central processing node. Similarly, when adapting from a star to a mesh topology, appropriate state information from the central node can be transferred to each of the end-nodes.

In another embodiment, the communication topology is dynamically adapted to reflect changing values of resource performance metrics and network performance metrics. In this way, the most efficient communication topology is implemented to provide the best performance of the virtual environment.

In another embodiment, the configuration of the communication topology promotes hysteresis to prevent unnecessary topology oscillations. That is, a cost of performance and economics is associated with adapting a communication topology to the current values of the resource performance metrics and the network performance metrics. For example, latency or delay in transmitting the communication signals may be introduced when shifting between topologies to support the addition or deletion of collaborators in the virtual environment.

In another embodiment, as the communication topology is adapted and configured according to performance metrics, the locations where computation is performed within the communication network shifts around. For example, when the topology shifts from a decentralized topology (e.g., mesh topology) to a more centrally located topology (e.g., star topology), much of the communication shifts from the end-user nodes to the central node. As a result, the computation is moved dynamically, as necessary, to meet various constraints, such as, computation, bandwidth, or low-power constraints.

The actual topology adaptation may be instrumented in a number of ways. For example, each node may be notified of a new IP address to communicate with (e.g., by a central server), the various nodes may negotiate among themselves to setup the new connections, the database in the DNS server may be changed to appropriately direct specific nodes to who they should communicate with, the multicast tree nodes may alter the tree topology they use, etc. There exists a significant amount of prior art in setting up connections between different nodes, and this prior art can be used by someone knowledgeable in the field to achieve the network adaptation as described.

As an example, consider the case of a device, such as, a laptop, or PDA, or cell phone that has limited power. These devices can operate in different modes that provide different tradeoffs in computation/power-consumption (e.g., different clock frequencies) or wireless-bandwidth/power-consumption. At the start of a communication session, the device may operate in a manner that uses its full computational capability. However, as the device slowly runs low on power, the topology can be changed so that less computation is performed at the device, and therefore allowing the device to operation in a computation/power consumption mode that is more power-efficient, and thereby extending its operational life.

In another embodiment, the topology is not necessarily changed when dynamically adapting or configuration the topology. Instead, the operation within the topology is changed. As such, computations may be performed at a different location within the same topology. For example, within a star topology, some computation may be changed from an end-node to a central node. This occurs without changing the star topology, and corresponds to adapting the operation of the system.

There are a number of topologies possible for supporting N to N communication, where the appropriate choice depends on the number of users N. FIGS. 3A, 3B, 3C, and 3D provide diagrams of varying communication topologies that are capable of supporting an N-way collaborative virtual environment, in accordance with embodiments of the present invention. A network topology is dynamically selected that most efficiently allows communication between the collaborators in the N-way collaborative environment. For example, in one embodiment, a full-mesh topology is most appropriate. In another embodiment, a star topology is most appropriate. In still other embodiments, a hybrid topology that combines features from the full-mesh topology and the star topology is most appropriate.

FIG. 3A is a diagram illustrating the virtual representation of communication paths in a full-mesh communication topology 300A. Most particularly, the full-mesh topology 300A is selected for the communication topology when there is a lesser amount of collaborators. That is, the full-mesh topology is appropriate when the number of users N is small (approximately 2-10), but probably not appropriate if the number of participants becomes much larger. This is because the number of point-to-point communication connections is large (scales as N\hat{ }2) and the computational complexity needed at a collaborator (local participant) is large (scales roughly as N).

As such, the full-mesh topology allows for complete richness in generating and receiving communication traffic in the N-way collaborative environment (e.g., a communicative environment). In a full-mesh topology, a plurality of communication paths couple each of the plurality of collaborators together for transmitting and receiving the view dependent image streams for each of the plurality of collaborators. For example, in FIG. 3A four collaborators are shown, collaborator 310A, 310B, 310C, and 310D at the noes in the topology 300A. By way of illustration, communication path 320 communicatively couples collaborator 310C to collaborator 310D, communication path 322 communicatively couples collaborator 310C to collaborator 310A, and communication path 324 communicatively couples collaborator 31C to collaborator 310B.

In one embodiment, a full-mesh topology is able to generate a 3-D model and viewpoint for every other user by the local collaborator. As such, the local computer generates and transmits N−1 streams, one for each of the other collaborators. As previously stated, this leads to a total of N(N−1) data streams that are transmitted for N collaborators. In addition, the local collaborator's computational requirements scales with the number of collaborators, since a new viewpoint may need to be generated for every other collaborator (N−1 viewpoints).

FIG. 3B is a diagram illustrating the virtual representation of communication paths in a star communication topology 300B, in accordance with one embodiment of the present invention. In particular, the star topology is selected for the communication topology supports a larger number of collaborators. The communication topology 300B comprises a central node/server 330 that is coupled to each of the N collaborators participating in an N-way collaborative environment (e.g., a communicative environment). The star topology 300B comprises the central server 330 for receiving and sending communication traffic between the plurality of nodes, and N connections coupling the plurality of nodes to the central server 330. Specifically, the central node/server 330 is communicatively coupled to collaborators 340A, 340B, 340C, and 340D.

In the star topology, communication between each of the collaborators is funneled through the central node/server 330. That is, the central node/server 330 receives and sends communication traffic between the plurality of nodes associated with the plurality of collaborators that are participating in the N-way collaborative environment. The central node/server 330 As shown in FIG. 3B, N=4 connections communicatively couple the N collaborators to the central node 330.

The star topology is most appropriate when there are a large number of collaborators. For network bandwidth efficiency, the star topology is capable of reducing the amount of communication traffic through the physical communication network, in one embodiment. In another embodiment, the star topology allows for better processing handling throughout the communication topology 300C. For instance, the central server/node 330 is capable of sharing some or most of the computational tasks for each of the collaborators at the nodes 340A-D. This is particularly useful when the devices associated with the nodes 340A-D have low processing power (e.g., cell phone).

For example, in the star topology, each collaborator sends information to a central node 330 which then generates the perspectives for each collaborator and then transmits the information to each collaborator. At a minimum, each collaboration computer in the star topology, located at each of the nodes, needs to send only sufficient information to the central node 330 for the central node 330 to compute the required viewpoint (e.g., of a local collaborator) for corresponding collaborators. In this case every collaborator need only connect to the central node 330. While the central node 330 needs to be quite powerful, only N separate connections are required. In addition, at each of the nodes associated with collaborators, the computational and communication requirements may be constant and independent of the number of collaborations. These are valuable properties for enabling scaling.

In the present embodiment, the plurality of nodes associated with each of the collaborators comprises low complexity processors. The goal in the present embodiment is to allow very low complexity collaboration computers to participate in the N-way collaborative environment. As such, laptops or personal digital assistants (PDAs) may be used as collaboration devices.

Further, in the present embodiment, the approach involves directly sending the multiple captured videos of a local collaborator (e.g., collaborator associated with node 340A) to the central node 330. As a result, the central node 330 performs most or all of the processing on the captured real-time videos of the local collaborator (at node 340A). As such, the central node 330 would perform the new view synthesis techniques to render output video image streams from the perspectives of collaborators that are viewing the local collaborator (at node 340A) in the N-way collaborative environment.

In addition, the synthetic N-way collaborative environment for each collaborator can be generated by the central node 330, and compressed as a video signal. This compressed video signal is then sent to the corresponding collaborative node. In this case, the collaborative node only needs a simple video decoder, leading once again to a very low complexity collaborative node.

In addition, a node such as a laptop or PDA may only have 1, 2, or 0 cameras for capturing real-time video streams of the local collaborator. However, the low complexity node can still collaborate because the node only requires a simple video decoder to view the synthetic N-way collaborative environment.

In another embodiment, topology adaptation allows for supporting view dependent communication in the N-way 3-D collaborative virtual environment. In this case, each of the plurality of nodes receives view dependent video image streams of the other collaborators for display within the three-dimensional virtual environment. As such, the central node/server 330 performs the processing necessary to generate view dependent video streams.

In the present embodiment, it is desirable for the collaborating computers to perform as many processing tasks as possible before sending information to the central node 330. This dramatically reduces the complexity requirements of the central node 330. For example, in one embodiment, any viewpoint-independent processing can be performed before sending the processed information to the central node 330. Correspondingly, the central node 330 performs the viewpoint-dependent processing for each collaborator.

As an example, if the 3-D model of a local collaborator (e.g., at node 340A) is viewpoint-independent then it can be computed at the collaborative node and sent to the central node 330. However, if the 3-D model is viewpoint dependent, then the view-independent pre-processing (e.g., image analysis, background segmentation, etc) steps may still be computed at the collaborative node. This still reduces the required processing by the central node.

As such, in the star topology 300B, the central server 330 performs view dependent processing for generating view dependent video streams. The central server 330 only performs view dependent processing to minimize a computational load at the central server 330. In this case, the central server 330 generates the view dependent video image streams for each of the collaborators at nodes 340A-D for each of the other collaborators in the N-way collaborative environment. As a result, each of the plurality of nodes 340A-D performs view independent processing for generating the view dependent video streams. The view independent processing in most cases requires less processing power to generate the view independent streams of data.

As a result, medium complexity collaborating computers are associated with the plurality of nodes associated with the collaborators. This allows for sharing of computational load throughout the communication network 300B, and minimizes the complexity of the central node 330.

FIG. 3C is a diagram illustrating the virtual representation of communication paths in a hybrid communication topology 300C, in accordance with one embodiment of the present invention. The hybrid topology 300C combines features of the full-mesh topology of FIG. 3A and the star topology of FIG. 3B. That is, the hybrid topology 300 comprises the simultaneous use of a central node/server in a star topology 360 connected to other nodes that are running a full-mesh topology. The full-mesh topology comprises node 350A, node 350B, node 350C, as well as central server 365 of the star topology 360.

In the hybrid topology 300C of FIG. 3C, a nodes 361A-C are communicatively coupled to the central node 365. The central node is capable of streaming communication traffic to a group of other collaborators that communicate amongst themselves. That is, the collaborators 350A-C along with the central node/server 365 communicate in a full-mesh topology. For example, the star topology 360 may comprise a group of low-power cellphone clients at nodes 361A-C. In this case, the central server/node 365 provides the processing power for generating communication data streams for the collaborators at nodes 361A-C to communicate amongst themselves, as well as with the collaborators at nodes 350A-C.

FIG. 3D is a diagram illustrating the virtual representation of communication paths in a hybrid communication topology 300D, in accordance with one embodiment of the present invention. The hybrid topology 300D combines features of the full-mesh topology of FIG. 3A and the star topology of FIG. 3B, as previously explained in relation to FIG. 3C. The topology in FIG. 3D comprises multiple star topologies 370, 380, and 390 that are communicatively coupled in a full-topology. That is, the central nodes 375, 385, and 395 of each of the star topologies 370, 380, and 390 are communicatively coupled.

For example twenty-four collaborating nodes are arranged in the three star topologies 370, 380, and 390. Eight collaborators may be communicatively coupled to central nodes of each star topology. For instance, collaborators 371A-N are communicatively coupled to the central server/node 375 of the star topology 370; collaborators 381A-N are communicatively coupled to the central server/node 385 of the star topology 380; and collaborators 391A-N are communicatively coupled to the central server/node 395 of the star topology 390. In addition, the central nodes 375, 385, and 395 are interconnected via a full-mesh topology.

An example application of the topology 300D is where three groups of people are participating in an N-way collaborative video conference at three different geographic locations (e.g., San Francisco, Chicago, and New York). In each of the cities, 8 people are distributed in different rooms in one or more neighboring buildings and are supported by a corresponding star topology.

In another embodiment, one performance metric that is measured to perform communication topology adaptation is the number of collaborators participating in the N-way collaborative environment. As such, the number of collaborators can be compared to a threshold. The threshold is designed to provide the most efficient network topology given the number of collaborators in the N-way collaborative environment. Thereafter, the present embodiment continues by adapting a communication topology to support the N-way collaborative environment based on the number of collaborators in relation to the threshold. By dynamically adapting the communication topology to the number of collaborators, the present embodiment is able to scale the communication network comprising the network topology to higher values of N.

Measuring the number of collaborators is one of a number of performance metrics that are measured when determining the network topology adaptation, in another embodiment. For example, performance metrics previously disclosed include, but are not limited to, number of collaborators, compute power, local memory, local bandwidth, network bandwidth, etc. A combination of all of these different performance metrics are considered to consider in adjusting and adapting the network topology. The configuration of the network topology is adapted to give the best performance and quality for communication between the collaborators. For example, the system can determine that some nodes are limited by their compute power, and must change and adapt to a topology that includes a compute server to assist in computation.

In the present embodiment, the preferred topology varies as a function of the number of nodes. For example if there are only 2-3 collaborators then a full-mesh may be appropriate, while if there are 10-15 collaborators, then a star topology may be appropriate. In another embodiment, it is valuable to move from a full-mesh to a star topology through hybrid topologies as the number of collaborators increases, as well as the reverse (if beneficial) if the number of collaborators decreases on an ongoing basis.

In another embodiment, the communication topology supports multicasting of multiple video image streams of a local collaborator that is participating in the N-way collaborative environment from varying viewpoints. The multicast video image streams are available for selection by observing collaborators. The observing collaborators then can display the multicasted video image streams of the local collaborator within the N-way collaborative environment.

Multicasting is an important approach to enable scalability, and occurs when multiple users can share the same content. As such, one version of the content is sent to collaborators who are sharing the content. Multicasting video image streams efficiently delivers these streams, in one embodiment. In another case, varying video image streams of a particular object within the N-way collaborative environment are produced and multicast to those collaborators that request a stream of data. For example, different (end-collaborator selected) viewpoints may be more important than other viewpoints. The end-collaborator, or viewing collaborator, may potentially also request different spatial or temporal resolutions, or bit rates. The remaining collaborators can select one video image stream of the object from the multiple video image streams that are available in multicast to the group of collaborators in the N-way collaborative environment.

In one embodiment, the multicast may be achieved via any communication protocol that supports multicasting, or via an application-layer multicast via an overlay network, in another embodiment.

In another embodiment, the communication topology supports generating view dependent video image streams in a format substantially complying with an object based Moving Pictures Experts Group (MPEG-4) communication standard. As a result, the receiver-portion of a collaborating computer is an MPEG-4 object-based decoder. The motivation is that objects/people in a scene can be expressed as a two-dimensional (2-D) image with potentially arbitrary shape (e.g., head-and-shoulders shape). The arbitrary shape portrays 3-D spatial position, perspective warping, and movement as a function of time. These objects (which are collaborators in the N-way collaborative environment) can be coded using MPEG-4 object-based coding. The objects are then transmitted in different MPEG-4/RTP/UDP/IP streams to a single receiver/decoder/renderer which can render the synthesized scene for collaboration within the N-way collaborative environment.

In another embodiment, some of the collaborators may be human and some may be computers. The previous discussion has focused on the case where the collaborators are all human. However, important applications include when some of the collaborators are human and some are computers. For example, a computer at one of the nodes may generate an avatar which provides the visual and audio attributes that are involved in the communication or collaboration. The computer and associated avatar may provide information (e.g. weather, scheduling information), may act as a consultant or assistant, may be involved as a player in a multi-player game, or may provide other forms of Human Computer Interaction (HCl).

In still another embodiment, the communication topology that is selected is capable of prioritizing data traffic based on an importance of objects associated with the data traffic. As such, data traffic in the communication topology comprising objects with higher importance have priority over data traffic for objects with lower importance. For example, given a number of objects, for example N head-and-shoulder objects when N people are collaborating, it is often the case that a subset of the objects are more important at a given time as compared to the others. In another example, the person who is speaking may be identified as having higher importance than someone in the back row who is simply listening.

In another embodiment, resolution of the objects associated with the data traffic is varied as a function of the importance. That is, data traffic for objects with higher importance have higher resolution than data traffic for objects with lower importance.

In a system implementing prioritizing based on importance, the objects identified as important should be prioritized for every aspect of the processing and transmission, e.g., analysis/modeling/rendering at the central node in a star topology, packet-level transmission opportunities from the central node to each of the collaboration nodes, etc. The preferential treatment of the important streams relative to the unimportant streams can have a significant positive effect when bottlenecks occur. For example, even when a system can not fully support N-way scalability, fully supporting the most important subset (and doing your best for the rest) may still enable many of the benefits of highly complex immersive N-way collaboration to be realized.

Also, preferred handling of data streams is performed at the host level, or end nodes, in accordance with one embodiment of the present invention. Priority handling at the host level can occur at the operating system (OS) or the application layer. As such, combined with the preferred handling of data streams at the network level, as described above, there is end-to-end handling of data streams on a priority basis. At the end nodes, data streams are handled and given use of computational resources depending on their associated priorities. As such, data packets with higher priorities are serviced before data packets with lower priorities.

In addition, the most important objects and their associated streams should be identified as such for any network quality of service (QoS) that may be available as well as for allocation of error control resources (e.g., FEC or retransmit opportunities) when transmitting over a lossy network.

There exists significant prior art in prioritizing the use of host computational, memory, bandwidth, network bandwidth, packet slots, network QoS capabilities, etc. which can be used by those knowledgeable in the art to achieve the network and host prioritizations, as described above. For illustrative purposes only, at the network level, prioritizing network traffic can be handled using differentiated services (DiffServ) over DiffServ connections, or by using the IEEE 802.11e protocols. Also, for illustrative purposes only, at the host level, prioritizing host traffic can be handled using an application, such as, Resource Containers.

In another embodiment, in a communication topology that includes a central server/node for processing communication data streams, confidentiality can be introduced. That is, when a central node performs the view-dependent processing for a local collaborator, this removes the requirement that each node knows about the other nodes involved in the collaboration. Usually, in a full-mesh topology (without a central node) the sending collaborator creates view dependent streams for each of the other collaborators.

This provides a number of benefits, ranging from reduced complexity, as previously described, as well as confidentiality of the nodes involved in the collaboration. For example, in an N-way collaborative environment where video image streams of a sending collaborator are transmitted to receiving collaborators, a receiving collaborator may not want the sending collaborator to know what the receiver is doing. As mentioned above, normally the sending collaborator would receive information about where the receiving collaborator is looking in order to create the appropriate view-dependent stream of the sending collaborator. However, the receiving collaborator may not want the sender collaborator to know where the receiver is looking, or if he is even looking, etc. This corresponds to the receiving collaborator desiring some amount of confidentiality. The receiving collaborator may achieve this by sending false information to the sending collaborator. Alternatively, the receiving collaborator may, in confidence, instruct the central node to send certain information to portray the receiver in a certain manner. This is an example of how the central node can act as a useful third-party in these collaborations, providing additional functionality, in this case confidentiality.

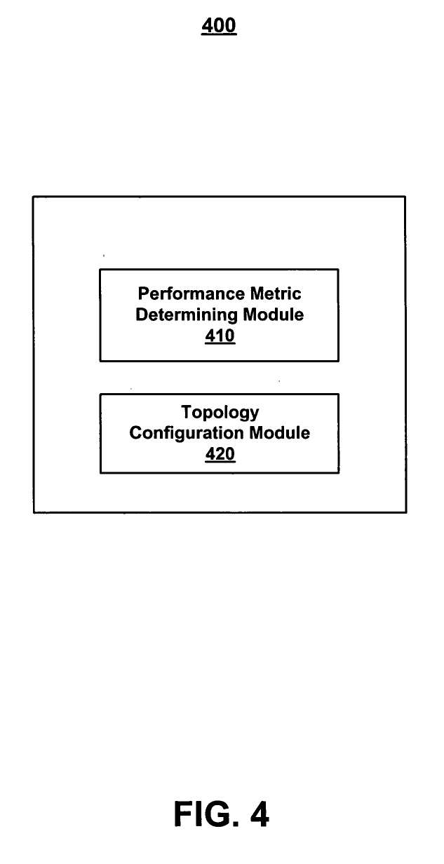

FIG. 4 is a block diagram of a system 400 that is capable of performing communication adaptation to support communication in a communicative environment. The system comprises a performance determining module 410 for measuring at least one performance metric for a plurality of nodes associated with a plurality of collaborators in the communicative environment. For example, the performance determining module may comprise a resource performance determining module and/or a network performance measuring module communicatively coupled together. The system 400 also comprises a topology configuration module 420 communicatively coupled to the performance measuring module 410. The topology configuration module 420 dynamically adapts a communication topology for linking the plurality of nodes in the communication network to support communication in the communicative environment based on the performance metric determined.

The preferred embodiments of the present invention, a method and system for topology adaptation to support a communicative environment, is thus described. While the present invention has been described in particular embodiments, it should be appreciated that the present invention should not be construed as limited by such embodiments, but rather construed according to the below claims.

1. A method for topology adaptation in a network, comprising:
determining at least one performance metric associated with a plurality of nodes in a communicative environment; and
dynamically adapting a communication topology for linking said plurality of nodes in a communication network to support communication in said communicative environment based on said at least one performance metric.

2. The method of claim 1, wherein said determining at least one performance metric further comprises:
determining at least one resource performance metric for a plurality of nodes associated with a plurality of collaborators in said communicative environment.

3. The method of claim 1, wherein said determining at least one performance metric further comprises:
determining at least one network performance metric for an underlying communication network that supports communication traffic between said plurality of nodes in said communicative environment.

4. The method of claim 1, further comprising:
adapting said communication topology for changing values of said at least one performance metric.

5. The method of claim 1, further comprising:
promoting hysteresis to prevent unnecessary topology oscillations when dynamically adapting said communication topology.

6. The method of claim 1, wherein said dynamically adapting a communication topology further comprises:
selecting said communication topology from a list essentially comprising:
a full-mesh topology, wherein said full-mesh topology comprises a plurality of communication paths coupling each of said plurality of collaborators together for transmitting and receiving user dependent data streams for each of said plurality of collaborators;
a star topology, wherein said star topology comprises a central server for receiving and sending user dependent data streams between said plurality of nodes, and N connections coupling said plurality of nodes to said central server; and
a hybrid topology that combines features from said star topology and said full-mesh topology.

7. The method of claim 6, wherein said user dependent data streams comprises view dependent data streams.

8. The method of claim 7, further comprising:
performing view dependent processing at said central server for generating said view dependent data streams; and
performing view independent processing at each of said plurality of nodes for generating said view dependent data streams to minimize said computational load at said central server.

9. The method of claim 7, further comprising:
providing confidentiality to a receiving collaborator at said central server by sending false information to a sending collaborator.

10. The method of claim 1, wherein said communication topology supports multicasting multiple video image streams of a local collaborator from varying viewpoints and resolution for selection by others of said plurality of collaborators for display.

11. The method of claim 1, further comprising:
prioritizing data traffic in said communication topology based on an importance of objects associated with said data traffic, wherein data traffic for objects with higher importance have priority over data traffic for objects with lower importance.

12. The method of claim 11, further comprising:
varying resolution of said objects associated with said data traffic as a function of said importance, wherein data traffic for objects with higher importance have higher resolution than data traffic for objects with lower importance.

13. The method of claim 1, further comprising:
prioritizing data traffic at each of said plurality of nodes based on an importance of objects associated with said data traffic, wherein data traffic for objects with higher importance have priority over data traffic for objects with lower importance.

14. The method of claim 1, wherein said dynamically adapting a communication topology further comprises:
dynamically relocating computational performance from one node to another node in said communication network when generating said communication traffic.

15. The method of claim 1, wherein said dynamically adapting a communication topology further comprises:
adapting said communication topology to adjust for changing power levels on at least one node in said plurality of nodes.

16. The method of claim 1, wherein at least one of said plurality of nodes comprises a computer resource that communicates through an associated avatar in said communicative environment.

17. A method for topology adaptation in a network, comprising:
determining at least one performance metric associated with a plurality of nodes in a virtual environment; and
configuring a communication topology for linking said plurality of nodes in a communication network to support communication in said virtual environment based on said at least one performance metric.

18. A topology manager for performing topology adaptation to support communication in an N-way collaborative virtual environment, comprising:
a performance determining module for determining at least one performance metric associated with a plurality of nodes in a virtual environment; and
a topology configuration module for dynamically adapting a communication topology for linking said plurality of nodes in a communication network to support communication in said virtual environment based on said at least one performance metric.

19. The topology manager of claim 18, wherein each of said plurality of nodes receives view dependent data streams from the other collaborators for display within an N-way collaborative virtual environment that comprises said virtual environment.

20. The topology manager of claim 18, wherein said performance determining module comprises:
a resource performance measuring module for measuring at least one resource performance metric for said plurality of nodes in virtual environment.

21. The topology manager of claim 18, wherein said performance determining module comprises:
a network performance measuring module for measuring at least one network performance metric for an underlying communication network that supports communication traffic between said plurality of nodes in said virtual environment;

22. The topology manager of claim 18, wherein said topology configuration module is capable of adapting said communication topology for changing values of said at least one performance metric.

23. The topology manager of claim 18, wherein said communication topology is taken from a list essentially comprising:
a full-mesh topology, wherein said full-mesh topology comprises a plurality of communication paths coupling each of said plurality of collaborators together for transmitting and receiving user dependent data streams for each of said plurality of collaborators;
a star topology, wherein said star topology comprises a central server for receiving and sending user dependent data streams between said plurality of nodes, and N connections coupling said plurality of nodes to said central server; and
a hybrid topology that combines features from said star topology and said full-mesh topology.

24. The topology manager of claim 18, wherein said communication topology supports generating view dependent data streams of a local collaborator in a format substantially complying with object based MPEG-4 communication standard.

25. The topology manager of claim 18, wherein said communication topology prioritizes data traffic in said communication topology based on an importance of objects transmitted in said communication, wherein data traffic for objects with higher importance have priority over data traffic for objects with lower importance.

26. A computer system comprising:
a processor; and
a computer readable memory coupled to said processor and containing program instructions that, when executed, implements a method for topology adaptation in a network, comprising:
determining at least one performance metric associated with a plurality of nodes in a communicative environment; and
dynamically adapting a communication topology for linking said plurality of nodes in a communication network to support communication in said communicative environment based on said at least one performance metric.

27. The computer system of claim 26, wherein said determining at least one performance metric in said method further comprises:
determining at least one resource performance metric for a plurality of nodes associated with a plurality of collaborators in said communicative environment.

28. The computer system of claim 26, wherein said determining at least one performance metric in said method further comprises:
determining at least one network performance metric for an underlying communication network that supports communication traffic between said plurality of nodes in said communicative environment.

29. The computer system of claim 26, wherein said method further comprises:
adapting said communication topology for changing values of said at least one performance metric.

30. The computer system of claim 29, wherein said method further comprises:
promoting hysteresis to prevent unnecessary topology oscillations when adapting said communication topology.

31. The computer system of claim 26, wherein said dynamically adapting a communication topology in said method further comprises:
selecting said communication topology from a list essentially comprising:
a full-mesh topology, wherein said full-mesh topology comprises a plurality of communication paths coupling each of said plurality of collaborators together for transmitting and receiving user dependent data streams for each of said plurality of collaborators;
a star topology, wherein said star topology comprises a central server for receiving and sending user dependent data streams between said plurality of nodes, and N connections coupling said plurality of nodes to said central server; and
a hybrid topology that combines features from said star topology and said full-mesh topology.

32. The computer system of claim 31, wherein said user dependent data streams comprises view dependent data streams.

33. The computer system of claim 31, wherein said method further comprises:
performing view dependent processing at said central server for generating said view dependent data streams; and
performing view independent processing at each of said plurality of nodes for generating said view dependent data streams to minimize said computational load at said central server.

34. The computer system of claim 31, wherein said method further comprises:
providing confidentiality to a receiving collaborator at said central server by sending false information to a sending collaborator.

35. The computer system of claim 26, wherein said communication topology supports multicasting multiple video image streams of a local collaborator from varying viewpoints and resolution for selection by others of said plurality of collaborators for display.

36. The computer system of claim 26, wherein said method further comprises:
prioritizing data traffic in said communication topology based on an importance of objects associated with said data traffic, wherein data traffic for objects with higher importance have priority over data traffic for objects with lower importance.

37. The computer system of claim 36, wherein said method further comprises:
varying resolution of said objects associated with said data traffic as a function of said importance, wherein data traffic for objects with higher importance have higher resolution than data traffic for objects with lower importance.

38. The computer system of claim 26, wherein said method further comprises:
prioritizing data traffic at each of said plurality of nodes based on an importance of objects associated with said data traffic, wherein data traffic for objects with higher importance have priority over data traffic for objects with lower importance.

39. The computer system of claim 26, wherein said dynamically adapting a communication topology in said method further comprises:
dynamically relocating computational performance from one node to another node in said communication network when generating said communication traffic.

40. A computer readable medium containing executable instructions which, when executed in a processing system, causes the system to perform the steps for a method for topology adaptation in a network, comprising:
determining at least one performance metric associated with a plurality of nodes in a communicative environment; and
dynamically adapting a communication topology for linking said plurality of nodes in a communication network to support communication in said communicative environment based on said at least one performance metric.
